(19) United States
(12) Patent Application Publication
(10) Pub. No.: US 2005/0063313 A1
(43) Pub. Date: Mar. 24, 2005

(54) Optimal clustering of master-slave ad-hoc wireless network

(75) Inventors: Amit Anil Nanavati, New Delhi (IN); Kannan Balaji, New Delhi (IN); Sanjiv Kapoor, New Delhi (IN)

Correspondence Address: McGinn & Gibb, PLLC, 2568-A Riva Road, Suite 304, Annapolis, MD, 21401, US

(73) Assignee: International Business Machines Corporation, Armonk, NY (US)

(21) Appl. No.: 09/898,162

(22) Filed: Jul. 3, 2001

(51) Int. Cl. H04L 12/28

(52) U.S. Cl. 370/252; 370/254

(57) ABSTRACT

The present invention relates to a system and method for optimal clustering of master-slave ad-hoc wireless network for minimizing the number of masters and thereby the number of communication hops. It comprises assigning master or slave status to each node and connecting slave nodes to master nodes to form subgroups based on defined optimization parameters and the constraints and characteristics of the network. After that said subgroups are interconnected to form a single cluster either by connecting a slave node at the boundary of one subgroup to the master of an adjacent subgroup where possible, or by connecting two adjacent master nodes together or by converting a slave node at the boundary to a master and linking it to the slave nodes or master nodes in the adjacent subgroups.

### FIELD OF THE INVENTION

The present invention relates to optimal clustering of master slave ad-hoc wireless networks.

### BACKGROUND OF THE INVENTION

Ad-hoc networks, which are studied in [1,2,5], are expected to play a significant role in future mobile computing applications. Bluetooth is an emerging technology for pervasive computing that allows for the replacement of the numerous proprietary cables that connect one device to another with short range radio links. This technology has applications in short-range wireless connectivity between pervasive devices, like PDAs, mobile phones, palmtops, laptops, pagers, etc. It is meant to be a cable-replacement solution for desktops, keyboards and other peripheral devices. The other potential applications include smart home appliances for establishing wireless connectivity to backbone data networks. In all of these applications, it is important for the devices to quickly self-organise themselves to communicate with other devices in the ad-hoc network. This work is intended to provide solution to this problem.

Bluetooth technology allows for the formation of network units called piconets and a connected set of piconets, called scatternets without the involvement of a central infrastructure, in an ad-hoc fashion. The centre of piconet is called the Master node, which is directly connected to a bounded number of Slave nodes. Connections between neighbouring piconets are through Bridge nodes, which could be of two types: Master-Slave Bridge (a Master in one piconet and a Slave in the neighbouring piconet), and Slave-Slave Bridge (a Slave node common to more than one piconet). However, the technology allows a node to belong to only one piconet at any point of time. This means, while a Master-Slave Bridge acts as a Slave in one piconet, all nodes in the piconet for which it is a Master will have to be idle. Clearly, Slave-Slave Bridges are more desirable for good performance. Moreover, the number of piconets to which a Slave-Slave Bridge is common, should be bounded for similar reasons.

The formation of clusters, and the related leader election problem had been investigated in [4]. These algorithms use a fair amount of messaging, which would prove to be expensive in Bluetooth. This problem has been investigated in [3]. However, solutions found can not be used since the clusterheads ‘Masters’ to be bounded and the communication between nodes in different clusters to be through ‘Bridge’ nodes, which are non-clusterhead nodes common to at least two clusters.

U.S. Pat. No. 6,026,303 describe the method for determining optimal terminal for an adhoc method system. This invention addresses the problem of dynamically determining the most optimal master node based on defined conditions of power consumption and communication error rates. U.S. patent application Ser. No. 09/634,123 describes a method and apparatus for forming clusters in wireless ad-hoc networks in a shortest possible time. Neither of these inventions addresses the issue of formation of clusters in a manner that minimizes the number of communication hops.

### TH OBJECT AND SUMMARY OF THE INVENTION

The object of this invention is to provide a method, system and computer program product that enables the clustering of ad-hoc wireless networks in a manner that minimizes the number of masters and thereby the number of communication hops.

To achieve the said objective, this invention provides a method for optimal clustering of master-slave ad-hoc wireless network, comprising:
assigning master or slave status to each node and connecting slave nodes to master nodes to form subgroups based on defined optimization parameters and the constraints and characteristics of the network;
interconnecting said subgroups to form a single cluster either by connecting a slave node at the boundary of one subgroup to the master of an adjacent subgroup where possible, or by connecting two adjacent master nodes together or by converting a slave node at the boundary to a master and linking it to the slave nodes or master nodes in the adjacent subgroups.

Each node is assigned master or slave based on the degree of connectivity of said node with other unassigned nodes.

The said assignment is implemented by a single entity located either within the cluster as one of the nodes or outside the cluster.

The formation of clusters and interconnection between the said clusters is based on weight associated with each node in the network where the weight of a node depends upon the number of nodes in its neighborhood.

The above method is applied to the formation of a scatternet in a Bluetooth network.

The said activities of assigning master or slave status to each node and interconnecting said subgroups are carried out in a distributed manner at each node further comprising:
assigning master or slave status to itself by each node based on the master or slave or unassigned status of all neighboring connected nodes,
forming subgroups around each master node,
merging said subgroups by forming slave-slave bridges or slave-master bridges or master-master bridges wherever possible based on network constraints or by forming additional masters where necessary.

The above method is applied to the formation of a Bluetooth scatternet.

The present invention further provides a system for optimal clustering of master-slave ad-hoc wireless network, comprising:
means for assigning master or slave status to each node and connecting slave nodes to master nodes to form subgroups based on defined optimization parameters and the constraints and characteristics of the network;
means for interconnecting said subgroups to form a single cluster either by connecting a slave node at the boundary of one subgroup to the master of an adjacent subgroup where possible, or by connecting two adjacent master nodes together or by converting a slave node at the boundary to a master and linking it to the slave nodes or master nodes in the adjacent subgroups.

The means for assigning master or slave status to each node is based on the degree of connectivity of said node with other unassigned nodes.

The means to implement the said assignment is carried out by a single entity located either within the cluster as one of the nodes or outside the cluster.

The formation of clusters and means for interconnection between the clusters is based on weight associated with each node in the network where the weight of a node depends upon the number of nodes in its neighborhood.

The above system is used for the formation of a scatternet in a Bluetooth network.

The said means for assigning master or slave status to each node and means for interconnecting said subgroups operate in a distributed manner at each node further comprising:
means for assigning master or slave status to itself by each node based on the master or slave or unassigned status of all neighboring connected nodes,
means for forming subgroups around each master node,
means for merging said subgroups by forming slave-slave bridges or slave-master bridges or master-master bridges wherever possible based on network constraints or by forming additional masters where necessary.

The said system is used for the formation of a Bluetooth scatternet.

The instant invention also provides a computer program product comprising computer readable program code stored on a computer program readable storage medium embodied therein for optimal clustering of master-slave ad-hoc wireless network, comprising:
computer readable program code means configured for assigning master or slave status to each node and connecting slave nodes to master nodes to form subgroups based on defined optimization parameters and the constraints and characteristics of the network;
computer readable program code means configured for interconnecting said subgroups to form a single cluster either by connecting a slave node at the boundary of one subgroup to the master of an adjacent subgroup where possible, or by connecting two adjacent master nodes together or by converting a slave node at the boundary to a master and linking it to the slave nodes or master nodes in the adjacent subgroups.

The computer readable program code means configured for assigning master or slave status to each node is based on the degree of connectivity of said node with other unassigned nodes.

The computer readable program code means configured to implement the said assignment is carried out by a single entity located either within the cluster as one of the nodes or outside the cluster.

The formation of clusters and computer readable program code means configured to interconnect between the clusters is based on weight associated with each node in the network where the weight of a node depends upon the number of nodes in its neighborhood.

The above computer program product is configured for the formation of a scatternet in a Bluetooth networks.

The said computer readable program code means for assigning master or slave status to each node and computer readable program code means for interconnecting said subgroups operate in a distributed manner at each node further comprising
computer readable program code means configured for assigning master or slave status to itself by each node based on the master or slave or unassigned status of all neighboring connected nodes,
computer readable program code means configured for forming subgroups around each master node,
computer readable program code means configured for merging said subgroups by forming slave-slave bridges or slave-master bridges or master-master bridges wherever possible based on network constraints or by forming additional masters where necessary.

The above computer program product is configured for the formation of a Bluetooth scatternet.

It may not be out of place to mention that the word “node” can be referred to as “Device” and vice-versa in this description.

Similarly the word “Subgroup” can be referred to as “cluster” and vice-versa.

### BRIEF DESCRIPTION OF THE DRAWINGS

The invention will now be described with reference to the accompanying drawings.

FIG. 1 shows the flow diagram for phase 1 of the centralized algorithm.

FIG. 2 show the flow diagram for phase II of the centralized algorithm.

FIG. 3 show the flow diagram for phase I of the distributed case algorithm.

FIG. 4 show the flow diagram for phase II of the distributed case algorithm.

### DETAILED DESCRIPTION OF THE DRAWINGS

In the description, by Bridge we mean a Slave-Slave Bridge, unless stated otherwise.

(a) Model:

In an ad-hoc network, we assume that all nodes are communicate over wireless links. We model the set of nodes as a graph, with an edge between a pair of nodes if they are in radio range of each other. It is assumed that a device can discover other devices within its radio range using device discovery protocols (DDP). This means in the graph every node discovers every other node in its neighborhood using the DDP. Every node in the graph is also assigned a weight which depends on (is a function of) the degree of the node (that is the number of neighbors of the node), power consumption of the node, maintenance overhead associated with the node and other defined optimisation parameters. The methods in this disclosure allocates Master/Slave labels to the nodes and clusters the nodes based on the defined optimisation parameters.

In the context of Bluetooth, the problem referred to as the scatternet formation problem (SFP) is to get a minimum set of connected star-shaped clusters of bounded size, say k₁. The connection between the stars is to be made through non-centre nodes, or Bridges, which, along with the clusterheads form the backbone of the network. We can also impose a bound of k₂ on the number of stars to which a Bridge can be common. However, if there is no such connected scatternet, then we allow direct communication between two centre nodes or Masters. This is because, in Bluetooth, the Master device controls the traffic to all the Slaves, and a node can be active in only one piconet at a time. This means if a device is an active Slave in one piconet, then during this time, the entire piconet for which this device is the Master, has to be idle. Similarly, a device which is a Slave in more than one piconet is active in only one of the piconets at a time, and hence the number of piconets to which a Slave can be common should be limited.

(b) Centralized Algorithms:

These algorithms assume that a central entity has the topology information of the entire network. In the following methods, the Master/Slave labeling is based on the effective degrees of the nodes. In general, when the nodes have weights attached to them, these methods should be interpreted appropriately. That is, in all these methods the degree/effective degree should be replaced by the weights associated with the nodes and the weights should be updated appropriately, wherever the methods update the effective degrees.

Method 1: This method proceeds in two phases. In the first phase it creates a forest and in the second phase it merges the trees in the forest. In the first phase of this method minimisation of the number of Masters is prioritised over establishing a connected backbone.

First Phase: In the first step of this phase all the nodes are set the label “unmarked” except for the node with the highest degree in the entire graph which is marked as a Master (if there are more than one node with highest degree the node with largest device id is picked). If the degree of the node marked as Master is less than the cluster size k₁ (the maximum number of Slaves that a Master can have), then all its neighbours are marked as its Slaves. Otherwise, the neighbour set of this node is sorted in non-decreasing order of degrees (with the nodes having the same degrees sorted in increasing order of their device id's) and the first k₁ nodes in the sorted list are marked as its Slaves.

In general, until all the nodes are marked either as “Master” or “Slave”, the algorithm iterates as follows: It picks up the node, say v, with the highest effective degree¹ (if there is a tie the node with largest device id is picked) and marks it a Master.
¹ The effective degree of an unmarked node is the degree of the node after removing the edges to the nodes that are marked as “Master” or “Slave”.

Suppose the node marked as Master is adjacent to one or more nodes marked as Slave in the previous iterations. Among these Slaves the node with smallest device id is made a Slave (a Bridge²) of v, the newly picked Master. Then, the unmarked neighbours of the Master node, v, are sorted in non-decreasing order of their effective degrees (the neighbours with same effective degrees are sorted in increasing order of their device id's) and the first k₁−1 neighbours in the sorted list are marked as Slaves to this Master.
² The bound on the Bridge should be taken care of, if it is specified.

Alternately, if the node marked as Master is not adjacent to any node marked as a Slave in the previous iterations, then the unmarked neighbours of this Master are sorted in non-decreasing order of their effective degrees (the neighbours with same effective degrees are sorted in increasing order of their device id's) and first k₁ neighbours in the sorted list are marked as Slaves to this Master.

Second Phase (Cleanup Phase): The forest obtained in the first phase is merged to get a single tree as follows³. As a first step, for every pair of trees Tᵢ and Tⱼ, if there is a node marked as slave in Tᵢ and adjacent to a node labelled Master in Tⱼ which is unsaturated⁴, then make the slave in Tᵢ also a Slave of the Master in Tⱼ (the Slave would be a Bridge node between these two Masters in Tᵢ and Tⱼ). By doing this, the trees Tᵢ and Tⱼ are merged. After the first step if the forest reduces to a single tree stop. Otherwise, as a second step for every pair of trees Tᵢ and Tⱼ examine whether there exists an edge between a Master in Tᵢ and a Master in Tⱼ. Then add the Master-Master edge between and merge the trees Tᵢ and Tⱼ. After Step 2, if there are more than one tree left in the forest proceed to Step 3, else stop. In Step 3, to merge two trees Tᵢ and Tⱼ look whether there is a node in Tᵢ labelled as Slave which is adjacent to a node labelled as Master in Tⱼ which is saturated⁵ (such a Slave can't be made a Slave of the Master to merge the two trees since the Master is saturated). If such a Slave exists in Tᵢ, then connect the trees by adding the edge between this Slave and the Master node in Tⱼ and, relabel the Slave as “Master”. If a single tree is obtained by merging, the algorithm stops, else proceeds to the next step. As a last step, for every pair of trees Tᵢ and Tⱼ do the following. Merge the trees Tᵢ and Tⱼ by adding an edge between a Slave of Tᵢ to a Slave of Tⱼ. Among these two Slaves one of these Slaves is relabelled as Master. This ends the second phase and the algorithm terminates. When the algorithm terminates a single tree is obtained.
³ While merging we prioritise reducing number of masters to maintaining connectivity.

⁴ A Master is unsaturated if some more Slaves can be added to it. That is it has less than k₁ Slaves, where k₁ is the number of Slaves a Master can have.

⁵ A saturated Master is a Master which is not unsaturated.

Method 2: This method differs from Method 1 in the first phase by prioritising, connected backbone establishment over minimisation of number of masters. The Phase 1 of this method is as follows.

Phase 1: Initially, all nodes are unmarked and their effective degree⁶ is set as its degree. The node with the highest effective degree in the entire graph is marked as a Master. If the effective degree of a node marked as Master is less than the cluster size, then all its neighbours are marked as its Slaves. Otherwise, the neighbour set of this node is sorted in the non-decreasing order of degrees and the first k₁ nodes are marked as its Slaves (if there is a tie the node with largest device id is picked). The neighbourhood of each Slave is searched for a node of the highest effective degree. This node is marked as the next Master and the corresponding Slave becomes a Bridge. The algorithm proceeds in a breadth-first fashion until all nodes are marked.
⁶ The notion of effective degree is same as in Method 1.

(c) Distributed Algorithms:

A node in the ad-hoc network executes these methods in two phases and self-organise itself as Master or Slave in the network. Even though in the following methods, a node labels itself Master/Slave based on its effective degree, in the general case, where weights are attached with every node, these methods can be interpreted appropriately as in the case of centralised algorithms.

Method 3: In the first phase every node labels itself Master or Slave and in the second phase they connect themselves to Masters which are not connected to it in the first phase. Each node runs the Algorithm till it gets assigned the label Master/Slave and starts the second phase after labelling itself and ensuring that its k-hop neighbourhood is completely labelled.

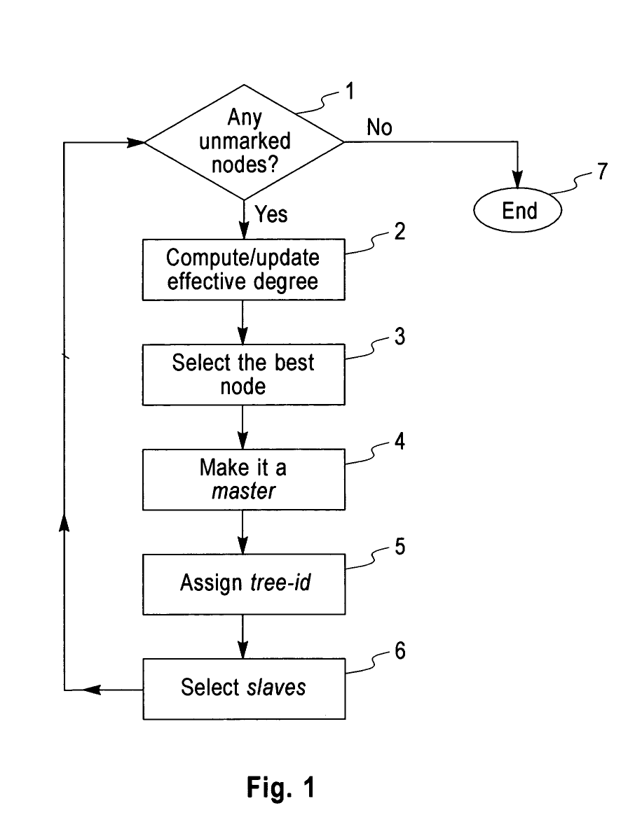

First Phase: Every node gets its k-hop neighbourhood information by message passing (that is the nodes which are l-hop and k-hop away from it and their degrees). After getting the k-hop neighbourhood information, every node labels itself “unmarked”. Then, the algorithm goes through several runs⁷ and in each run the nodes either remain unmarked or mark itself Master or Slave by the following rule. If a node finds itself to be the largest effective degree⁸ node in its k-hop neighbourhood then the node marks itself a Master (if there is more than one node with largest effective degree in the k-hop neighbourhood of a node inclusive of itself, the node marks itself a “Master” if it is of largest device id among these nodes). After a node say v, marks itself a Master it examines whether it is adjacent to a node which is already marked as a Slave. If it finds such a set of nodes S, it requests the node with the smallest device-id in S to be its Slave⁹ (to be a Bridge node between this Master, v, and the Masters for which this node is a Slave). Then, v, sorts its unmarked neighbours in non-decreasing order of their effective degrees (if there are more than one node with same effective degree then they are sorted on increasing order of their device id's) and requests the first k₁−1 nodes to become its Slave. The requested nodes marks themselves as Slaves for the requesting Master. If the node v, after marking itself a Master, doesn't find itself adjacent to any Slave it proceeds as follows. The Master node v, sorts its unmarked neighbours in non-decreasing order of their effective degrees (if there are more than one node with same effective degree then they are sorted on increasing order of their device id's) and requests the first k₁ nodes to become its Slave. The requested nodes mark themselves as Slaves for the requesting Master. This ends the first phase. As a result of first phase, a forest is formed. Every node also gets a tree-id in the first phase for identifying whether the node and another node in its k-hop neighbourhood belong to the same tree or not, as follows. In every run a Slave inherits the tree-id of its Master and every Master either assigns itself a new tree-id (which could be its device-id) or inherits the tree-id of the Bridge. FIG. 1 shows the flowchart of phase I.
⁷ In every “run” a node checks whether it can make itself a master by looking at its k-hop neighbourhood. If it can't then goes to a sleep state till the effective degree of some node in its k-hop neighbourhood changes. If it can, then as a first step marks itself a Master, as a second step wakes some of its neighbours and requests them to become its slave (following the algorithm).

⁸ The effective degree of an unmarked node is the degree of the node after removing the edges to the nodes that are marked as “Master” or “Slave”.

⁹ The requested node marks itself a Slave for the requesting Master.

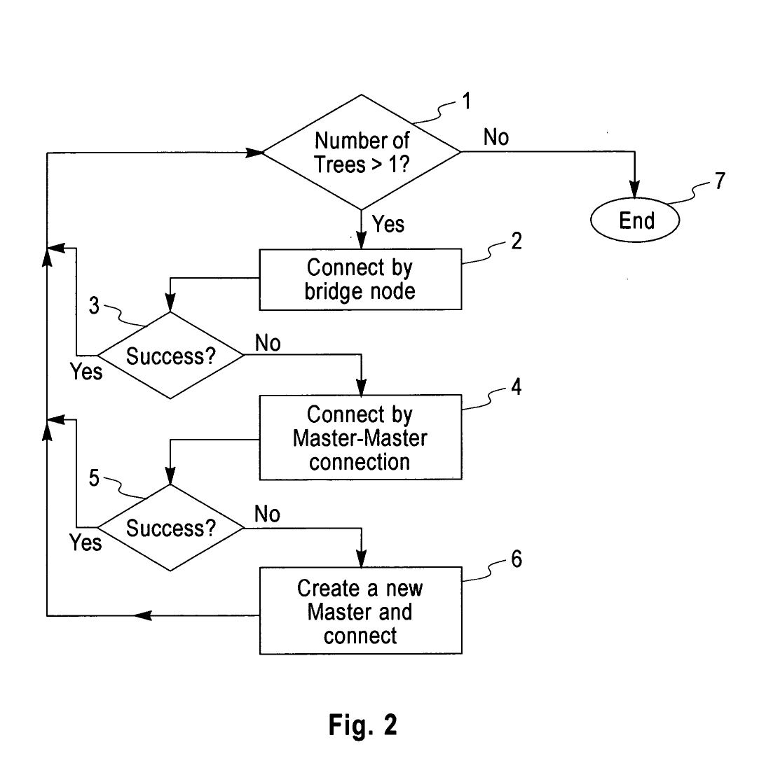

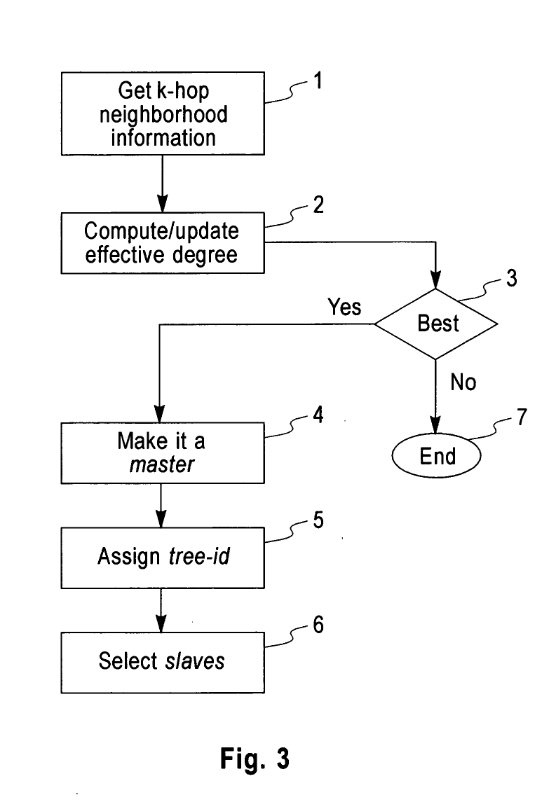

Second Phase: The second phase of the algorithm connects the different trees in the forest formed in the first phase by the following rule¹⁰. A Master tries to connect to every other Master in its k-hop neighbourhood which are of different tree-id's through one of its Slaves (that is finds whether one of its Slaves could also become a Slave for the other unsaturated¹¹ Master). If not, it connects to neighbouring Masters by Master-Master edge. For each remaining Master in its k-hop neighbourhood, it looks for a Slave that is adjacent to each such Master, and relabels its Slave as Master, introducing a Master-Master edge. For each non-neighbouring Slave (with a different tree-id) in its k-hop neighbourhood, it picks the node with lowest device id among its Slaves. The Slave picked (i) relabels itself as Master, (ii) adds the Master-Master edge corresponding to its adjacent Master and (iii) requests a Slave (with a different tree-id), to be its Slave (Bridge). The requested Slave marks itself a Slave of the requesting Master. This completes the second phase of the algorithm. At the end of the second phase, every node is connected to every other node in the network through the backbone obtained by this algorithm. FIG. 2 shows the flowchart of phase II. FIG. 3 shows the details.
¹⁰ Minimising the number of masters is prioritised over establishing connectivity. So, the algorithm goes through the following steps one after another.

¹¹ A Master is unsaturated if some more Slaves can be added to it. That is it has less than k₁ Slaves, where k₁ is the number of Slaves a Master can have.

The following methods are variations of Method 3.

Method 4: This method is same as Method 3, except for the following in its first phase. In every run a node marks itself a “Master” if either (i) condition (a) followed by condition (b) holds,
(a) it is adjacent to a slave or a set of slaves¹² which is/are unsaturated¹³,
   ¹² Tie is broken using device id.
   ¹³ A unsaturated slave is similar to the definition of a unsaturated master, if there is a bound on the number of masters for which the slave could serve as a bridge.
(b) among the nodes which are adjacent to the unsaturated node if it of highest effective degree¹⁴ in its k-hop neighborhood,
   ¹⁴ Tie is broken using device id.
   or (ii) if there is no node in its k-hop neighborhood which satisfies (i) and it is of highest effective degree¹⁵ in its k-hop neighborhood.
   ¹⁵ Tie resolved using device id.

Method 5: This method is same as Method 3, except for the following in its second phase. A master connects to some other master, say v, which is of different tree-id passes the information to every other master in its k-hop neighborhood that it has connected to v and vice versa, v passes this information to every master in its k-hop neighborhood. This information would prevent other masters with same tree-id getting connected to v and vice versa.

Method 6: This method is same as Method 5, except for the following. A master u after connecting to another master v in its k-hop neighborhood updates its tree-id as max(tree-id(u), tree-id(v)) and passes the updated tree-id to every master which was having the same tree-id as of that before the update, vice versa, v also does the same.

### DETAILED DESCRIPTION OF THE FIGURES

FIG. 1 describes the Phase 1 of the Centralized Algorithm.

The following procedure is repeated till every node is marked as Master or Slave.

Step 1: If there are unlabelled nodes in the network (1) (which are not marked as Master or Slave) a centralized node (which is in the network or outside the network) computes/updates the effective degree (2) (weights in the general case) for all the unlabelled nodes as in Phase 1 of Method 1.

Step 2: Pick the best node v (3) (of largest effective degree and largest device id among all the nodes in the network) and go to Step 3.

Step 3: The node v is made a Master (4).

Step 4: A tree-id (5) is assigned for v as per the procedure described in Phase 1 of Method 1.

Step 5: The slaves of v are selected and marked as Slave (6) as per the procedure described in Phase 1 of Method 1. Then go to Step 1.

FIG. 2 describes the Phase 2 of the Centralized Algorithm.

The following procedure is repeated till the number of trees (clusters) reduces to 1.

Step 1: If the number of trees is greater than 1 (1) then go to Step 2 (2), else end the procedure (7).

Step 2: Connect the trees via a bridge as described in Phase 2 of Method 1. If yes then go to Step 1, else go to Step 3.

Step 3: Connect the trees via Master-Master link (4) as described in Phase 2 of Method 1. If yes then go to Step 1, else go to Step 4.

Step 4: Create a new master and connect (6) the trees via the new master as described in Phase 2 of Method 1. Then go to Step 1.

We note that the order of Step 2, Step 3 and Step 4 may vary depending on the priorities set on the optimization parameters.

FIG. 3 describes the Phase 1 of the Distributed Algorithm.

The following procedure is repeated till every node marks itself a Master or Slave.

Every node v, which has not yet labeled itself as Master or Slave, goes through these steps.

Step 1: Gets its k-hop neighborhood information (1).

Step 2: Computes the effective degrees of all the unlabelled (which are hot marked as Master or Slave) nodes (2) as in Phase 1 of Method 3.

Step 3: If it finds itself the best node (3) (of largest effective degree and largest device id among all the nodes in its k-hop neighborhood) then it goes to Step 3.

Step 4: It marks itself a Master (4).

Step 5: It assigns itself a tree-id (5) as per the procedure described in Phase 1 of Method 3 (6).

Step 6: It requests some of the nodes in its k-hop neighborhood to become its slaves as per the procedure described in Phase 1 of Method 3. The requested nodes marks itself Slave.

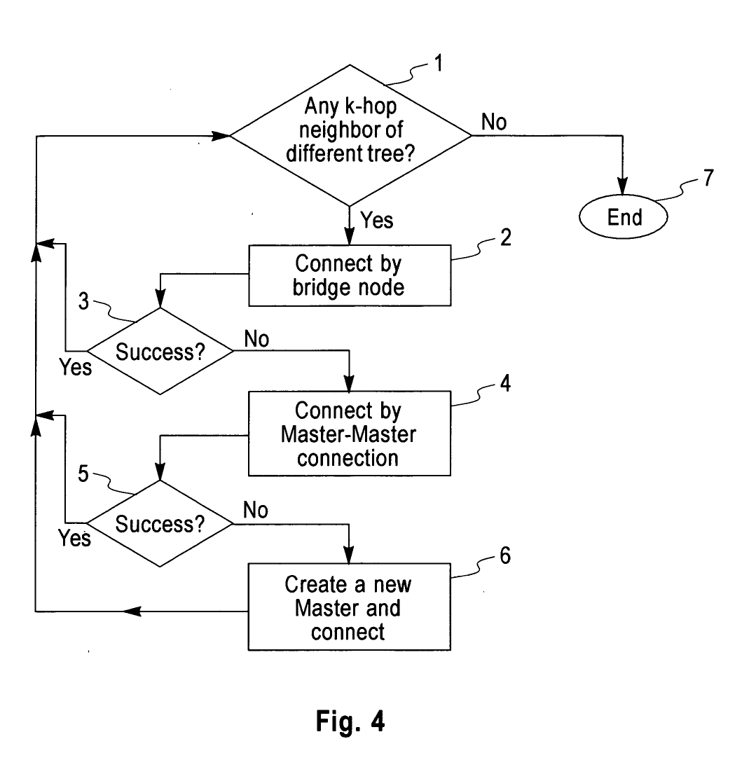

FIG. 4 describes the Phase 2 of the Distributed Algorithm.

Every node connects to the nodes in its k-hop neighborhood, which belongs to the trees (1) other than the tree to which it belongs (of different cluster than its cluster). They go through the following steps to connect themselves to the other clusters.

Step 1: Connect to the trees via a bridge (2) as described in Phase 2 of Method 3. If yes then stop else go to Step 2.

Step 2: Connect to the trees via Master-Master link (4) as described in Phase 2 of Method 3. If yes then stop, else go to Step 3.

Step 3: Create a new master and connect (6) to the trees via the new master as described in Phase 2 of Method 3.

We note that the order of Step 1, Step 2 and Step 3 may vary depending on the priorities set on the optimization parameters.

### REFERENCES CITED

[1] R. Krishnan, R. Ramanathan, M. Streenstrup, “Optimization algorithms for large self-structuring networks”. IEEE INFOCOM 1999.
[2] C. V. Ramamoorthy, J. Srivatsava and W. T. Tsai, “Clustering techniques for large distributed systems,” IEEE INFOCOM 1986.
[3] J. Wu and H. Li, “On calculating connected dominating set for efficient routing in ad hoc wireless networks,” DIAL M '99.
[4] L. Ramachandran, M. Kapoor, A. Sarkar, A. Aggarwal, “Clustering algorithms for wireless ad hoc networks,” DIAL M 2000.
[5] B. Das, E. Sivkumar and V. Bhargavan, “Routing in ad hoc networks using a spine,” IEEE Int. Conf. On Computers, Communication, and Networks, pp.1-20 (IC3N), September 1997.

1. The method for optimal clustering of master-slave ad-hoc wireless network, comprising:
assigning master or slave status to each node and connecting slave nodes to master nodes to form subgroups based on defined optimization parameters and the constraints and characteristics of the network;
interconnecting said subgroups to form a single cluster either by connecting a slave node at the boundary of one subgroup to the master of an adjacent subgroup where possible, or by connecting two adjacent master nodes together or by converting a slave node at the boundary to a master and linking it to the slave nodes or master nodes in the adjacent subgroups.

2. A method as claimed in claim 1, wherein each node is assigned master or slave based on the degree of connectivity of said node with other unassigned nodes.

3. A method as claimed in claim 1, wherein said assignment is implemented by a single entity located either within the cluster as one of the nodes or outside the cluster.

4. A method as claimed in claim 1, wherein the formation of clusters and interconnection between the said clusters is based on weight associated with each node in the network where the weight of a node depends upon the number of nodes in its neighborhood.

5. A method as claimed in claim 1 is applied to the formation of a scatternet in a Bluetooth network.

6. A method as claimed in claim 1 wherein activities in steps 1 and 2 are carried out in a distributed manner at each node further comprising:
assigning master or slave status to itself by each node based on the master or slave or unassigned status of all neighboring connected nodes,
forming subgroups around each master node,
merging said subgroups by forming slave-slave bridges or slave-master bridges or master-master bridges wherever possible based on network constraints or by forming additional masters where necessary.

7. A method as claimed in claim 6 is applied to the formation of a Bluetooth scatternet.

8. The system for optimal clustering of master-slave ad-hoc wireless network, comprising:
means for assigning master or slave status to each node and connecting slave nodes to master nodes to form subgroups based on defined optimization parameters and the constraints and characteristics of the network;
means for interconnecting said subgroups to form a single cluster either by connecting a slave node at the boundary of one subgroup to the master of an adjacent subgroup where possible, or by connecting two adjacent master nodes together or by converting a slave node at the boundary to a master and linking it to the slave nodes or master nodes in the adjacent subgroups.

9. A system as claimed in claim 8, wherein means for assigning master or slave status to each node is based on the degree of connectivity of said node with other unassigned nodes.

10. A system as claimed in claim 8, wherein means to implement the said assignment is carried out by a single entity located either within the cluster as one of the nodes or outside the cluster.

11. A system as claimed in claim 8, wherein the formation of clusters and means for interconnection between the clusters is based on weight associated with each node in the network where the weight of a node depends upon the number of nodes in its neighborhood.

12. A system as claimed in claim 8 is used for the formation of a scatternet in a Bluetooth network.

13. A system as claimed in claim 8, wherein said means in steps 1 and 2 operate in a distributed manner at each node further comprising:
means for assigning master or slave status to itself by each node based on the master or slave or unassigned status of all neighboring connected nodes,
means for forming subgroups around each master node,
means for merging said subgroups by forming slave-slave bridges or slave-master bridges or master-master bridges wherever possible based on network constraints or by forming additional masters where necessary.

14. A system as claimed in claim 13 is used for the formation of a Bluetooth scatternet.

15. The computer program product comprising computer readable program code stored on a computer program readable storage medium embodied therein for optimal clustering of master-slave ad-hoc wireless network, comprising:
computer readable program code means configured for assigning master or slave status to each node and connecting slave nodes to master nodes to form subgroups based on defined optimization parameters and the constraints and characteristics of the network;
computer readable program code means configured for interconnecting said subgroups to form a single cluster either by connecting a slave node at the boundary of one subgroup to the master of an adjacent subgroup where possible, or by connecting two adjacent master nodes together or by converting a slave node at the boundary to a master and linking it to the slave nodes or master nodes in the adjacent subgroups.

16. A computer program product as claimed in claim 15, wherein computer readable program code means configured for assigning master or slave status to each node is based on the degree of connectivity of said node with other unassigned nodes.

17. A computer program product as claimed in claim 15, wherein computer readable program code means configured to implement the said assignment is carried out by a single entity located either within the cluster as one of the nodes or outside the cluster.

18. A computer program product as claimed in claim 15, wherein the formation of clusters and computer readable program code means configured to interconnect between the clusters is based on weight associated with each node in the network where the weight of a node depends upon the number of nodes in its neighborhood.

19. A computer program product as claimed in claim 15 is configured for the formation of a scatternet in a Bluetooth networks.

20. A computer program product as claimed in claim 15 wherein computer readable program code means in steps 1 and 2 operate in a distributed manner at each node further comprising:
computer readable program code means configured for assigning master or slave status to itself by each node based on the master or slave or unassigned status of all neighboring connected nodes,
computer readable program code means configured for forming subgroups around each master node,
computer readable program code means configured for merging said subgroups by forming slave-slave bridges or slave-master bridges or master-master bridges wherever possible based on network constraints or by forming additional masters where necessary.

21. A computer program product as claimed in claim 20 is configured for the formation of a Bluetooth scatternet.
